(19) United States
(12) Patent Application Publication
(10) Pub. No.: US 2024/0313443 A1
(43) Pub. Date: Sep. 19, 2024

(54) Connector and Device Comprising The Same

(71) Applicants: Tyco Electronics (Dongguan) Ltd., Dongguan City (CN); Tyco Electronics (Shanghai) Co., Ltd., Shanghai (CN)

(72) Inventors: Fuding (Mike) Qiu, Dongguan (CN); Ping Hou, Dongguan (CN); Xinjie (David) Zhang, Shanghai (CN); Keping Wan, Dongguan (CN)

(73) Assignees: Tyco Electronics (Dongguan) Ltd., Dongguan City (CN); Tyco Electronics (Shanghai) Co., Ltd., Shanghai (CN)

(21) Appl. No.: 18/605,952

(22) Filed: Mar. 15, 2024

(30) Foreign Application Priority Data
Mar. 15, 2023 (CN) 202310251983.5

(51) Int. Cl. H01R 12/53; H01R 13/506; H01R 24/60; H01R 107/00

(52) U.S. Cl. CPC H01R 12/53; H01R 13/506; H01R 24/60; H01R 2107/00

(57) ABSTRACT

A connector includes a housing, a circuit board inserted into the housing and having a plurality of first terminals located on a pair of opposite sides of the circuit board at a rear end of the circuit board, a plurality of wires including a plurality of connecting terminals that are each electrically connected to one of the first terminals, and a fixing mechanism mounted in the housing and fixing the wires on the circuit board. The connecting terminals and the first terminals are exposed outside the fixing mechanism.

### CROSS-REFERENCE TO RELATED APPLICATION

This application claims the benefit of the filing date under 35 U.S.C. § 119(a)-(d) of Chinese Patent Application No. 202310251983.5, filed on Mar. 15, 2023.

### FIELD OF THE INVENTION

The present disclosure relates to a connector and a device comprising the connector.

### BACKGROUND

A connector is a device used to connect two active devices to transmit current or signals. A connector may simplify an assembly process of electronic product and also simplify a mass production process of the electronic products. A connector is easy to repair, and if an electronic component fails, the failed component may be quickly replaced with a connector installed. With an advancement of technology, the electronic product equipped with a connector may use updated electronic components, replacing old electronic components with new and better performing ones for easy upgrading. A connector may enhance a flexibility of product design when designing and integrating a new product, as well as when composing a system with electronic components. Therefore, connectors are widely used in fields such as transportation, healthcare, aerospace, military, and home appliances.

The basic performances of a connector may be divided into three categories: mechanical performance, electrical performance, and environmental performance.

Insertion and extraction force and mechanical life are important mechanical performances. The insertion and extraction force and mechanical life of a connector are related to a structure of a contact (a magnitude of a positive pressure), a quality of a coating on a contact area (sliding friction coefficient), and an accuracy of a size of an arrangement of the contacts (alignment precision).

Main electrical performances of a connector comprise a contact resistance, an insulation resistance, and a dielectric strength. Among them, a high-quality electrical connector should have a low and stable contact resistance, which ranges from a few milliohms to tens of milliohms. An insulation resistance is an index that measures the insulation performance between the contacts of an electrical connector and between the contacts and a housing of the connector. An order of magnitude of the insulation resistance ranges from hundreds of megaohms to thousands of megaohms. Dielectric strength is an ability of a connector to withstand a rated test voltage between the contacts of the connector or between the contacts and the housing.

Environmental performance comprises a temperature resistance, a humidity resistance, a salt spray resistance, a vibration and an impact resistance, etc.

The development of connector technology presents the following characteristics: high-speed and digitalization of signal transmission, integration of various signal transmissions, miniaturization of product volume, low cost of products, modular combination, convenience of insertion and extraction, and so on.

In connectors used for transmitting high-speed signals, a circuit board is usually mounted in a front housing, which is then assembled onto a rear housing so as to cover the circuit board and wires soldered onto the circuit board. Adhesive is coated to an entire solder pad area of the circuit board to secure the wires onto the solder pad, and plastic is injected into the front housing and rear housing so as to further secure the wires thereon. However, the front housing, rear housing, and the circuit board are all assembled structures that require high dimensional accuracy for each of the components, otherwise it is difficult to assemble the front housing, rear housing, and circuit board together; and the adhesive may cause an increase in a dielectric constant in the solder pad area, leading to a deterioration of signal integrity. It is also easy for the plastic to escape from the housing and thus it is difficult to control the plastic.

### SUMMARY

A connector includes a housing, a circuit board inserted into the housing and having a plurality of first terminals located on a pair of opposite sides of the circuit board at a rear end of the circuit board, a plurality of wires including a plurality of connecting terminals that are each electrically connected to one of the first terminals, and a fixing mechanism mounted in the housing and fixing the wires on the circuit board. The connecting terminals and the first terminals are exposed outside the fixing mechanism.

### BRIEF DESCRIPTION OF THE DRAWINGS

Features of the present invention will become more apparent by describing in detail exemplary embodiments thereof with reference to the accompanying drawings, in which:

FIG. 1 is a perspective view of a connector according to an embodiment of the present disclosure;

FIG. 2 is an exploded view of the connector in FIG. 1, wherein a first fixing member is not provided on the circuit board and a second fixing member is not connected to the first fixing member;

FIG. 3 is an exploded view of the connector in FIG. 1, wherein the first fixing member is provided on the circuit board and the second fixing member is not connected to the first fixing member;

FIG. 4 is an exploded view of the connector in FIG. 1, wherein the first fixing member is provided on the circuit board and the second fixing member is connected to the first fixing member; and

FIG. 5 is a perspective view of an individual housing of the connector in FIG. 1, showing an accommodating portion of the housing.

### DETAILED DESCRIPTION OF EMBODIMENTS

In order to make the purpose, technical scheme and advantages of the present disclosure more clear, the following is a detailed explanation of the present disclosure, combined with specific embodiments and referring to the attached drawings. The accompanying drawings incorporated therein and forming a part of the specification illustrate the present disclosure and, together with the description, further serve to explain the principles of the disclosure and to enable those skilled in the relevant art to manufacture and use the embodiments described herein.

However, it should be understood that these descriptions are only illustrative and not intended to limit the scope of the present disclosure. In the following detailed description, for case of interpretation, many specific details are elaborated to provide a comprehensive understanding of the embodiments of the present disclosure. However, it is evident that one or more embodiments may also be implemented without these specific details. In addition, in the following explanation, the description of the well-known technology is omitted to avoid unnecessary confusion with the concept of the present disclosure.

The terms used here are only for describing specific embodiments and are not intended to limit the present disclosure. The term “comprising” used here indicates the existence of features, steps and operations, but does not exclude the existence or addition of one or more other features.

In the case of using expressions such as “at least one of A, B, and C, etc.” or the like, it should generally be interpreted in accordance with the meaning of the expressions that those skilled in the art usually understand (for example, “a system with at least one of A, B, and C” should comprise but not be limited to a system with only A, a system with only B, a system with only C, a system with A and B, a system with A and C, a system with B and C, and/or a system with A, B, C, etc.).

All terms used here (comprising technical and scientific terms) have the meanings commonly understood by those skilled in the art, unless otherwise defined. It should be noted that the terms used here should be interpreted as having a meaning consistent with the context of this specification, and should not be interpreted in an idealized or overly rigid manner.

The features disclosed in this disclosure will become more apparent in the following detailed description in conjunction with the accompanying drawings, where similar reference numerals identify corresponding components. In the accompanying drawings, similar reference numerals typically represent identical, functionally similar, and/or structurally similar components. Unless otherwise stated, the drawings provided throughout the entire disclosure should not be construed as drawings drawn to scale.

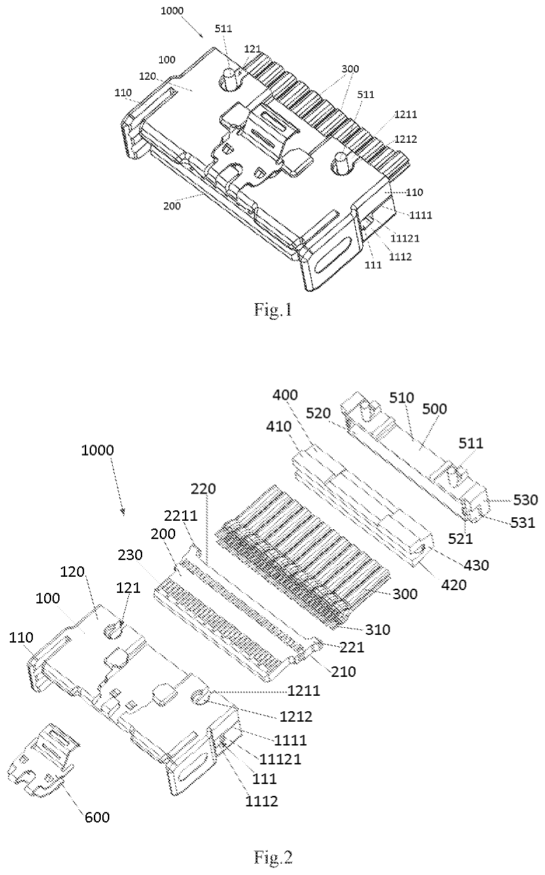

Referring to FIGS. 1 to 5, the present disclosure discloses a connector 1000 and a device comprising the connector 1000. The connector 1000 comprises a housing 100, a circuit board 200, a plurality of wires 300, and a fixing mechanism. The circuit board 200 is inserted into the housing 100 and comprises a plurality of first terminals 210 located on its opposite sides at the rear end of the circuit board 200 and a plurality of second terminals 230 located on its opposite sides at the front end of the circuit board 200 (see FIGS. 2 to 4). One type of the first terminals 210 and the second terminals 230 are used as input terminals, and the other type of the first terminals 210 and the second terminals 230 are used as output terminals.

Each of the plurality of wires 300 comprises an insulation layer and connecting terminals 310 (i.e., conductors of the wires 300, such as metal cores) that extend from the insulation layer and are electrically connected to corresponding ones of the first terminals 210. The fixing mechanism is mounted in the housing 100 so as to fix the plurality of wires 300 onto the circuit board 200, so that the connecting terminals 310 and the first terminals 210 are exposed outside the fixing mechanism.

In prior art, adhesive is coated to an entire solder pad area of the circuit board 200 to fix the connection terminals 310 of the wires 300 to the first terminals 210 respectively, which would result in an increase in a dielectric constant at the solder pad area, deterioration of a signal integrity, difficulty in controlling a distribution of the adhesive on the circuit board 200 due to fluid properties of the adhesive, and which is also not convenient for the assembly of the connector 1000.

The present disclosure fixes the plurality of wires 300 onto the circuit board 200 through the fixing mechanism, which is formed by injection molding on the circuit board 200 and the plurality of wires 300, so that the connecting terminals 310 and the first terminals 210 are exposed outside the fixing mechanism without being covered by the fixing mechanism or any dielectric. This effectively avoids the increase in the dielectric constant at the solder pad area, improves the signal integrity, and improves the assembly of the connector 1000.

The fixing mechanism comprises a first fixing member 400 and a second fixing member 500. The first fixing member 400 is disposed on the rear end of the circuit board 200 and the front ends of the plurality of wires 300 through injection molding so as to fix the plurality of wires 300 to the circuit board 200 and expose the connecting terminals 310 and the first terminals 210 to environment. A molding temperature of the first fixing member 400 is, for example, 220° C., and the molding material used is hot melt adhesive, with no pressure setting (or with a lower pressure). Compared to the larger and uncontrollable coverage area of the adhesive on the circuit board 200 in the prior art, the coverage area of the first fixing member 400 formed by injection molding on the circuit board 200 is reduced by about half, and the thickness of the first fixing member 400 may be precisely controlled, allowing for parameterized adjustment of the dielectric constant of the solder pad area, and greatly improving the signal integrity.

The housing 100 is provided with a cuboid-shaped accommodating portion 130, as shown in FIG. 5, which is provided with an opening for partially accommodating the circuit board 200 and the second terminals 230 so that a front end of the first fixing member 400 abuts against a rear end of the accommodating portion 130 when the circuit board 200 is inserted into the housing 100, so as to limit positions of the first fixing member 400 and the circuit board 200 in the housing 100, and facilitate the assembly of the connector 1000.

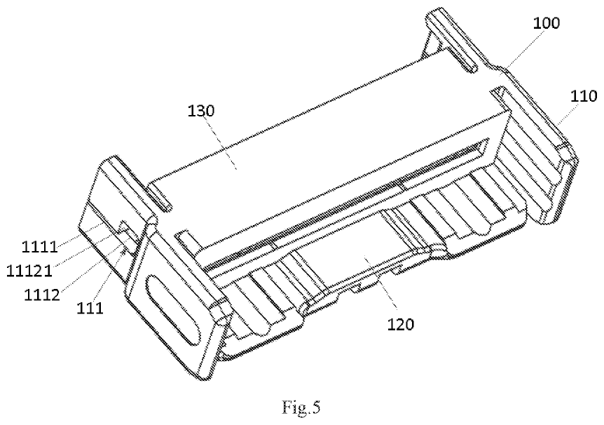

The second fixing member 500 is located behind the first fixing member 400 and is placed on the insulation layer of the plurality of wires 300 immediately adjacent to the first fixing member 400 through injection molding, as shown in FIG. 4, so as to further strengthen fixed connection between the plurality of wires 300 and the circuit board 200. The molding temperature of the second fixing member 500 is, for example, 185° C., the molding material is resin with high fluidity, and the molding pressure is, for example, 15 Mpa. Under the above conditions, injection molding is carried out without preheating settings for the molds, and the molding time is relatively short. The heat resistance temperature of the circuit board 200 reaches 220° C. or above, and the heat resistance temperature of the conductors and the insulation layer of each of the wires 300 reaches 300° C. or above, which will not have adverse effects on the circuit board 200 and wires 300.

The hardness of the second fixing member 500 is greater than that of the first fixing member 400. As the first fixing member 400 is located in front of the second fixing member 500, as shown in FIG. 4, it is possible to prevent the resin that constitutes the second fixing member 500 from flowing to the connecting terminals 310 and the first terminals 210 to cover the connecting terminals 310 and the first terminals 210 during injection molding. The second fixing member 500 replaces the rear housing and the injection molded filling material filled in the rear housing in the prior art, which simplifies the structure of the connector 1000, and may precisely control the dimensions of the first fixing member 400 and the second fixing member 500 through injection molding, ensuring the smooth installation of the first fixing member 400 and the second fixing member 500 into the housing 100.

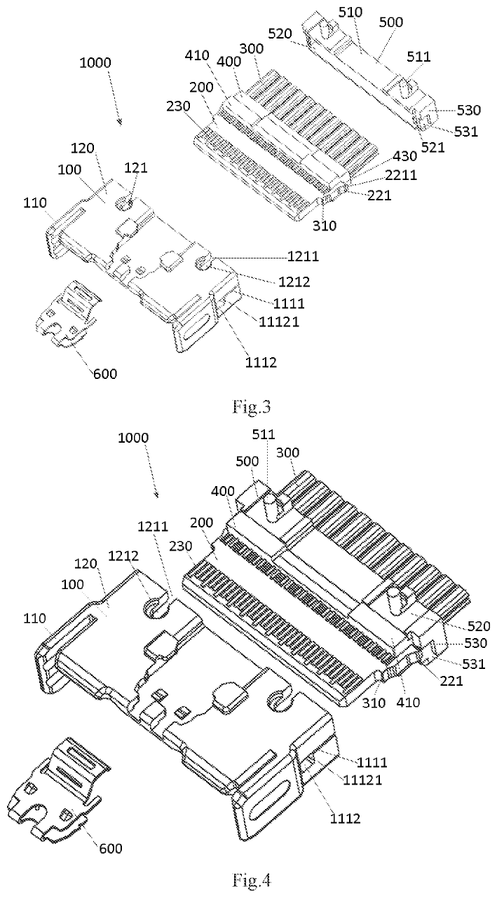

Referring to FIGS. 2 to 4, the first fixing member 400 comprises a first top wall 410, a first bottom wall 420, and two opposite first side walls 430 respectively connected between the first top wall 410 and the first bottom wall 420 at the rear ends of the first top wall 410 and the first bottom wall 420. The first top wall 410 and the first bottom wall 420 are pressed against the plurality of wires 300 on opposite sides of the circuit board 200 respectively, and a front end of each of the first side walls 430 is abutted against a rear edge 220 of the circuit board 200 so as to fix the wires 300 onto the circuit board 200. The circuit board 200 is provided with two opposite fingers 221 extending obliquely from the rear edge 220 so as to abut against an outer side of corresponding one of the first side walls 430, as shown in FIG. 3.

The housing 100 comprises two opposite side walls 110, each of which is provided with a first groove 111, and the accommodating portion 130 is provided between the opposite side walls 110, as shown in FIG. 5. The first groove 111 is used to fixedly accommodate the finger 221 and fix the circuit board 200 into the housing 100 when the circuit board 200 is inserted into the housing 100. As shown in FIG. 2, the first groove 111 comprises a first channel 1111 and a first hole 1112 communicated with the first channel 1111, so that the finger 221 moves into the first hole 1112 along the first channel 1111, and a free end 2211 of the finger partially abuts against a back wall 11121 of the first hole 1112 when the circuit board 200 is inserted into the housing 100, preventing the circuit board 200 from detaching from the housing 100 in a direction opposite to the insertion direction.

Referring to FIGS. 2 to 4, the second fixing member 500 comprises a second top wall 510, a second bottom wall 520, and two opposite second side walls 530 respectively connected between the second top wall 510 and the second bottom wall 520, wherein each of the first top wall 410 and the first bottom wall 420 is configured as a stepped shape so as to be in a snap-on connection with corresponding one of the second top wall 510 and the second bottom wall 520, so as to secure the first fixing member 400 and the second fixing member 500 together, realizing the further fixation of the wires 300 to the circuit board 200. Those skilled in the art should be aware that the present disclosure is not limited to this, the first top wall 410 and the first bottom wall 420 may also be configured as any other shape that may be in a snap-on connection with the second top wall 510 and the second bottom wall 520 respectively.

The second top wall 510 is provided with two protrusions 511 that protrude upwards (see FIGS. 1 to 4). The housing 100 comprises a top wall 120 provided with two second grooves 121, each of which is used to fixedly accommodate corresponding one of the protrusions 511 when the circuit board 200 is inserted into the housing 100, in order to further fix the circuit board 200 and wires 300 into the housing 100. As shown in FIG. 2, the second groove 121 comprises a second channel 1211 and a second hole 1212 communicated with the second channel 1211, so that the protrusion 511 is inserted into the second hole 1212 along the second channel 1211 and is buckled or riveted into the second hole 1212 through a hot riveting process when the circuit board 200 is inserted into the housing 100. Although in this embodiment, the protrusion 511 is configured as a cylindrical shape, the present disclosure is not limited to this, and the protrusion 511 may be configured as any other shape that is buckled or fixed into the second hole 1212. The second fixing member 500 is further provided with two inserts 521, each of which extends from corresponding one of the second side walls 530 (see FIGS. 2 to 3), and the first side wall 430 is provided with an insert groove at its rear end for the insert 521 to be inserted therein, so as to further fix the first fixing member 400 and the second fixing member 500 together.

The second side wall 530 is provided with a recess 531 on its outer side, so that the free end of the finger 221 partially abuts against the front end of the second side wall 530 when the second fixing member 500 is connected to the first fixing member 400, so as to limit the position of the second fixing member 500 and facilitate the assembly of the connector 1000. The portion of the free end of the finger 221 exposed in the recess 531 does not abut against the front end of the second side wall 530, but instead abuts against the back wall 11121 of the first hole 1112 after the circuit board 200 is inserted into the housing 100, preventing the circuit board 200 from detaching from the housing 100 in a direction opposite to the insertion direction.

There is a groove on the top wall 120 of the connector 1000 for mounting a fastener 600 (see FIGS. 1 to 4), which is used to fix a mating connector of connector 1000 to connector 1000. The first top wall 410 and the second top wall 510 are correspondingly formed with a concave portion matched with the groove, so that the first fixing member 400 and the second fixing member 500 may be inserted into the housing 100 in a shape matching manner.

A detailed description of the embodiments of the present disclosure has been provided in conjunction with the accompanying drawings. It should be noted that the implementation not shown or described in the accompanying drawings or the text of the specification are all forms known to the person skilled in the art that the present disclosure pertains to and have not been explained in detail. In addition, the above definitions of each of the components are not limited to the various specific structures, shapes, or methods mentioned in the embodiments, which may be easily modified or replaced by the person skilled in the art.

It should also be noted that in specific embodiments of the present disclosure, unless otherwise expressly stated, the numerical parameters in this specification and the attached claims are approximate values that may be changed based on the desired characteristics obtained by the content of the present disclosure. Specifically, all numbers used in the specification and claims to represent the dimensions, range conditions, etc. of the composition should be understood as being modified by the term “approximately” in all cases. In general, the meaning of the expression refers to an inclusion of a specific number of ±10% changes in some embodiments, ±5% changes in some embodiments, ±1% changes in some embodiments, and ±0.5% changes in some embodiments.

The person skilled in the art may understand that the features recorded in various embodiments and/or claims of the present disclosure may be combined or incorporated in a plurality of ways, even if such combinations or incorporations are not explicitly recorded in the present disclosure. Specifically, without departing from the spirit and teachings of the present disclosure, the features recorded in various embodiments and/or claims of the present disclosure may be combined and/or incorporated in a plurality of ways. All these combinations and/or incorporations fall within the scope of the present disclosure.

The specific embodiments described above provide further detailed explanations of the purpose, technical scheme, and beneficial effects of the present disclosure. It should be understood that the above explanations are only specific embodiments of the present disclosure and are not intended to limit the present disclosure. Any modifications, equivalent replacements, improvements, etc. made within the spirit and principles of the present disclosure should be comprised in the protection scope of the present disclosure.

What is claimed is:

1. A connector, comprising:
a housing;
a circuit board inserted into the housing and having a plurality of first terminals located on a pair of opposite sides of the circuit board at a rear end of the circuit board;
a plurality of wires including a plurality of connecting terminals that are each electrically connected to one of the first terminals; and
a fixing mechanism mounted in the housing and fixing the wires on the circuit board, the connecting terminals and the first terminals are exposed outside the fixing mechanism.

2. The connector of claim 1, wherein the fixing mechanism includes a first fixing member on the circuit board and the wires, the first fixing member exposes the connecting terminals and the first terminals.

3. The connector of claim 2, wherein the fixing mechanism includes a second fixing member on the wires adjacent to the first fixing member.

4. The connector of claim 3, wherein the first fixing member has a first top wall, a first bottom wall, and a pair of opposite first side walls connected between the first top wall and the first bottom wall at a pair of rear ends of the first top wall and the first bottom wall.

5. The connector of claim 4, wherein the first top wall and the first bottom wall are pressed against the wires on the pair of opposite sides of the circuit board, and a front end of each of the first side walls abuts against a rear edge of the circuit board.

6. The connector of claim 5, wherein the circuit board has a pair of opposite fingers extending obliquely from the rear edge and each abutting against an outer side of one of the first side walls.

7. The connector of claim 6, wherein the housing has a pair of opposite side walls, each of the side walls has a first groove fixedly accommodating one of the fingers.

8. The connector of claim 7, wherein the first groove has a first channel and a first hole communicated with the first channel, the one of the fingers moves into the first hole along the first channel.

9. The connector of claim 8, wherein a free end of the one of the fingers partially abuts against a back wall of the first hole.

10. The connector of claim 6, wherein the second fixing member has a second top wall, a second bottom wall, and a pair of opposite second side walls respectively connected between the second top wall and the second bottom wall.

11. The connector of claim 10, wherein each of the first top wall and the first bottom wall has a stepped shape and is in a snap-on connection with one of the second top wall and the second bottom wall.

12. The connector of claim 11, wherein the second top wall has a pair of upward protruding protrusions.

13. The connector of claim 12, wherein the housing has a top wall with a pair of second grooves fixedly accommodating the protrusions.

14. The connector of claim 13, wherein each of the second grooves has a second channel and a second hole communicated with the second channel.

15. The connector of claim 14, wherein the one of the protrusions is inserted into the second hole along the second channel and caught in the second hole.

16. The connector of claim 13, wherein the second fixing member has an insert extending from one of the second side walls, one of the first side walls has an insert groove at a rear end receiving the insert.

17. The connector of claim 16, wherein the one of the second side walls has a recess on an outer side, a free end of one of the fingers partially abuts against a front end of the one of the second side walls when the second fixing member is connected to the first fixing member.

18. The connector of claim 2, wherein the circuit board has a plurality of second terminals on the pair of opposite sides of the circuit board at a front end of the circuit board.

19. The connector of claim 18, wherein the housing has an accommodating portion accommodating the second terminals and a front end of the first fixing member abuts against a rear end of the accommodating portion.

20. A device, comprising:
a connector including a housing, a circuit board inserted into the housing and having a plurality of first terminals located on a pair of opposite sides of the circuit board at a rear end of the circuit board, a plurality of wires including a plurality of connecting terminals that are each electrically connected to one of the first terminals, and a fixing mechanism mounted in the housing and fixing the wires on the circuit board, the connecting terminals and the first terminals are exposed outside the fixing mechanism.
